(19) United States
(12) Patent Application Publication
(10) Pub. No.: US 2014/0040526 A1
(43) Pub. Date: Feb. 6, 2014

(54) COHERENT DATA FORWARDING WHEN LINK CONGESTION OCCURS IN A MULTI-NODE COHERENT SYSTEM

(71) Applicants: Bruce J. Chang, Saratoga, CA (US); Sebastian Turullols, Los Altos, CA (US); Brian F. Keish, San Jose, CA (US); Damien Walker, San Jose, CA (US); Ramaswamy Sivaramakrishnan, San Jose, CA (US); Paul N. Loewenstein, Palo Alto, CA (US)

(72) Inventors: Bruce J. Chang, Saratoga, CA (US); Sebastian Turullols, Los Altos, CA (US); Brian F. Keish, San Jose, CA (US); Damien Walker, San Jose, CA (US); Ramaswamy Sivaramakrishnan, San Jose, CA (US); Paul N. Loewenstein, Palo Alto, CA (US)

(21) Appl. No.: 13/563,586

(22) Filed: Jul. 31, 2012

(51) Int. Cl. G06F 13/38

(52) U.S. Cl. 710/316

(57) ABSTRACT

Systems and methods for efficient data transport across multiple processors when link utilization is congested. In a multi-node system, each of the nodes measures a congestion level for each of the one or more links connected to it. A source node indicates when each of one or more links to a destination node is congested or each non-congested link is unable to send a particular packet type. In response, the source node sets an indication that it is a candidate for seeking a data forwarding path to send a packet of the particular packet type to the destination node. The source node uses measured congestion levels received from other nodes to search for one or more intermediate nodes. An intermediate node in a data forwarding path has non-congested links for data transport. The source node reroutes data to the destination node through the data forwarding path.

### BACKGROUND OF THE INVENTION

1. Field of the Invention

This invention relates to high performance computing network systems, and more particularly, to maintaining efficient data transport across multiple processors when links between the processors are congested.

2. Description of the Relevant Art

The performance of computing systems is dependent on both hardware and software. In order to increase the throughput of computing systems, the parallelization of tasks is utilized as much as possible. To this end, compilers may extract parallelized tasks from program code and many modern processor core designs have deep pipelines configured to perform chip multi-threading (CMT). In hardware-level multi-threading, a simultaneous multi-threaded processor core executes hardware instructions from different software processes at the same time. In contrast, single-threaded processors operate on a single thread at a time.

In order to utilize the benefits of CMT on larger workloads, the computing system may be expanded from a single-socket system to a multi-socket system. For example, scientific computing clusters utilize multiple sockets. Each one of the multiple sockets includes a processor with one or more cores. The multiple sockets may be located on a single motherboard, which is also referred to as a printed circuit board. Alternatively, the multiple sockets may be located on multiple motherboards connected through a backplane in a server box, a desktop, a laptop, or other chassis.

In a symmetric multi-processing system, each of the processors shares one common store of memory. In contrast, each processor in a multi-socket computing system includes its own dedicated store of memory. In a multi-socket computing system, each processor is capable of accessing a memory store corresponding to another processor, transparent to the software programmer. A dedicated cache coherence link may be used between two processors within the multi-socket system for accessing data stored in caches or a dynamic random access memory (DRAM) of another processor. Systems with CMT use an appreciable amount of memory bandwidth. The dedicated cache coherence links in a multi-socket system provide near-linear scaling of performance with thread count.

The link bandwidth between any two processors in a multi-socket system may be limited due to the link being a single, direct link and multiple request types sharing the link. In addition, a processor in a socket may request most of its data packets from a remote socket for extended periods of time. Accordingly, the requested bandwidth may exceed the bandwidth capacity of the single direct coherence link. The congestion on this link may limit performance for the multi-socket system. Some solutions for this congestion include increasing the link data rate, adding more links between the two nodes, and increasing number of lanes per link. However, these solutions are expensive and may use more time for development than allowed by a time-to-market constraint, and may add an appreciable amount of increased power consumption.

In view of the above, methods and mechanisms for efficient data transport across multiple processors when link utilization is congested are desired.

### SUMMARY OF THE INVENTION

Systems and methods for efficient data transport across multiple processors when link utilization is congested are contemplated. In one embodiment, a computing system includes multiple processors, each located in a respective socket on a printed circuit board. Each processor includes one or more processor cores and one or more on-die caches arranged in a cache hierarchical subsystem. A processor within a socket is connected to a respective off-die memory, such as at least dynamic random access memory (DRAM). A processor within a socket and its respective off-die memory may be referred to as a node. A processor within a given node may have access to a most recently updated copy of data in the on-die caches and off-die memory of other nodes through one or more coherence links.

Each of the nodes in the system may measure a congestion level for each of the one or more links connected to it. A link may be considered congested in response to a requested bandwidth for the link exceeding the bandwidth capacity of the link. When a given node determines a given link is congested, the given node may become a candidate for data forwarding and use one or more intermediate nodes to route data. A source node may determine whether each of the one or more links connected to a destination node has a measured congestion level above a given threshold or is unable to send a particular packet type. In response to this determination, the source node may set an indication that the source node is a candidate for seeking data forwarding using intermediate nodes to send a packet of the particular packet type to the destination node.

The source node may use measured congestion levels received from each of the other nodes in the system to search for one or more intermediate nodes. A data forwarding path with a single intermediate node has a first link between the source node and the intermediate node with a measured congestion level below a low threshold. In addition, a second link between the intermediate node and the destination node has a measured congestion level below a low threshold. The source node may reroute data to the destination node through the first link, the intermediate node, and the second link. In other cases, the data forwarding path includes multiple intermediate nodes.

These and other embodiments will become apparent upon reference to the following description and accompanying drawings.

### BRIEF DESCRIPTION OF THE DRAWINGS

FIG. 1 is a generalized block diagram illustrating one embodiment of a computing system.

FIG. 2 is a generalized block diagram illustrating another embodiment of an exemplary node.

FIG. 3 is a generalized block diagram illustrating one embodiment of link congestion measurement.

FIG. 4 is a generalized block diagram illustrating one embodiment of a global congestion table.

FIG. 5 is a generalized flow diagram illustrating one embodiment of a method for transporting data in a multi-node system.

FIG. 6 is a generalized flow diagram illustrating one embodiment of a method for determining whether a link is a candidate for seeking a data forwarding path.

FIG. 7 is a generalized flow diagram illustrating one embodiment of a method for routing data in a multi-node system with available data forwarding.

FIG. 8 is a generalized flow diagram of one embodiment of a method for forwarding data in an intermediate node.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, signals, computer program instruction, and techniques have not been shown in detail to avoid obscuring the present invention.

A socket is an electrical and mechanical component on a printed circuit board. The socket may also be referred to as a central processing unit (CPU) socket. Without soldering, the socket connects the processor to other chips and buses on the printed circuit board. Sockets are typically used in desktop and server computers. In contrast, portable computing devices, such as laptops, use surface mount processors. Surface mount processors consume less space on a printed circuit board than a socket, but also need soldering.

Whether socket or surface mount technology is used, a computing system may include multiple processors located on one or more printed circuit boards. Each processor of the multiple processors includes one or more on-die caches arranged in a cache hierarchical subsystem. Additionally, each processor core may be connected to a respective off-die memory. The respective off-die memory may include at least a dynamic random access memory (DRAM).

Each one of the multiple processors may include one or more general-purpose processor cores. The general-purpose processor cores may execute instructions according to a given general-purpose instruction set. Alternatively, a processor within a node may include heterogeneous cores, such as one or more general-purpose cores and one or more application specific cores. The application specific cores may include a graphics processing unit (GPU), a digital signal processor (DSP), and so forth.

Whether socket or surface mount technology is used, a processor, its on-die cache memory subsystem, and its respective off-die memory may be referred to as a node. A processor within a given node may have access to a most recently updated copy of data in the on-die caches and off-die memory of other nodes through one or more coherence links. Through the use of coherence links, each processor is directly connected to one or more other processors in other nodes in the system, and has access to on-die caches and a respective off-die memory of the one or more other processors. Examples of the interconnect technology for the coherence links include HyperTransport and QuickPath. Other proprietary coherence link technologies may also be selected for use.

The link bandwidth between any two nodes in a multi-node system may be limited due to the link being a single, direct link and multiple request types share the link. The requested bandwidth may exceed the bandwidth capacity of the single direct coherence link. In various embodiments, through the use of hardware and/or software, each node may be able to determine an alternate forwarding path for data transport requests targeting a destination node. The node may send the data transport requests on the alternate path using intermediate nodes, rather than on an original, direct path to the destination node. Further details are provided below.

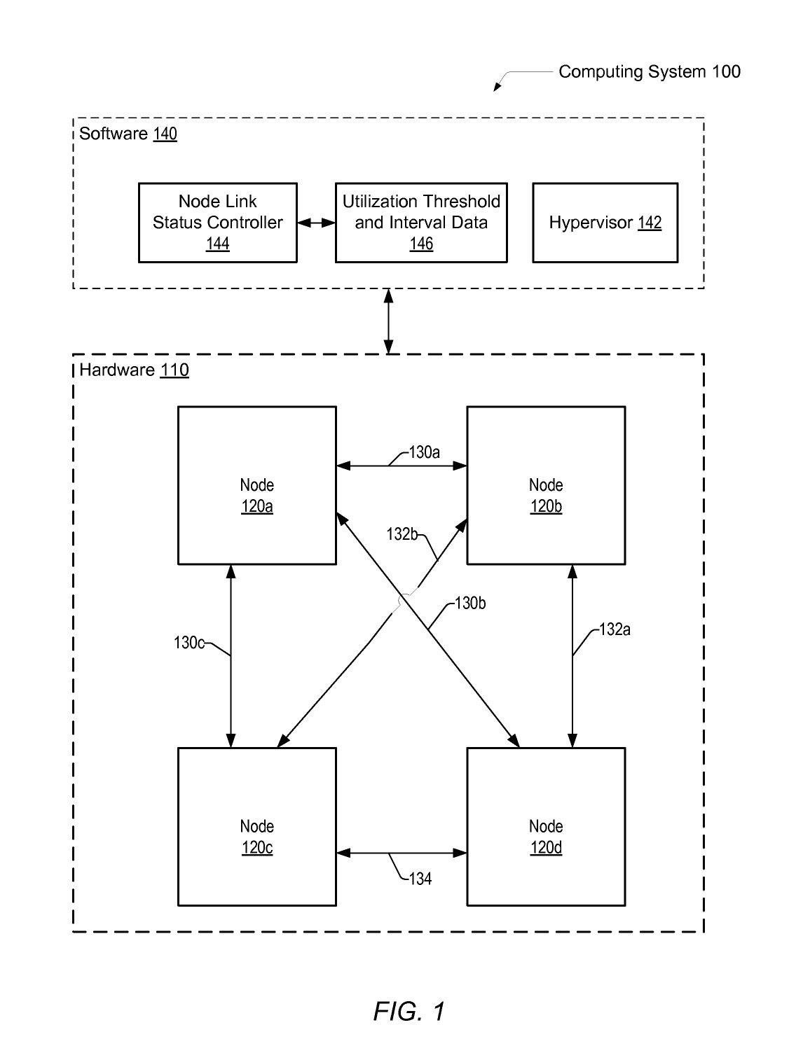

Referring to FIG. 1, a generalized block diagram illustrating one embodiment of a computing system 100 is shown. Computing system 100 includes hardware 110 and software 140. The hardware 110 includes nodes 120a-120d. Although four nodes are shown in FIG. 1, other embodiments may comprise a different number of nodes. As described above, each one of the nodes 120a-120d may include a processor and its respective off-die memory. The processor may be connected to a printed circuit board with socket or surface mount technology. Through the use of coherence links 130a-130c, 132a-132b, and 134, each processor within the nodes 120a-120d is connected to another one of the processors in the computing system 100 and has access to on-die caches and a respective off-die memory of the other one of the processors in another node.

In some embodiments, the nodes 120a-120d are located on a single printed circuit board. In other embodiments, each one of the nodes 120a-120d is located on a respective single printed circuit board. In yet other embodiments, two of the four nodes 120a-120d are located on a first printed circuit board and the other two nodes are located on a second printed circuit board. Multiple printed circuit boards may be connected for communication by a back plane.

Whether a processor in each one of the nodes 120a-120d is connected on a printed circuit board with socket or surface mount technology, the processor may be connected to a respective off-die memory. The off-die memory may include dynamic random access memory (DRAM), a Buffer on Board (BoB) interface chip between the processor and DRAM, and so forth. The off-die memory may be connected to a respective memory controller for the processor. The DRAM may include one or more dual in-line memory module (DIMM) slots. The DRAM may be further connected to lower levels of a memory hierarchy, such as a disk memory and offline archive memory.

Memory controllers within the nodes 120a-120d may include control circuitry for interfacing to memories. Additionally, the memory controllers may include request queues for queuing memory requests. In one embodiment, the coherency points for addresses within the computing system 100 are the memory controllers within the nodes 120a-120d connected to the memory storing bytes corresponding to the addresses. In other embodiments, the cache coherency scheme may be directory based, and the coherency point is the respective directory within each of the nodes 120a-120d. The memory controllers may include or be connected to coherence units. In a directory-based cache coherence scheme, the coherence units may store a respective directory. These coherence units are further described later. Additionally, the nodes 120a-120d may communicate with input/output (I/O) devices, which may include various computer peripheral devices. Alternatively, each one of the nodes 120a-120d may communicate with an I/O bridge, which is coupled to an I/O bus.

As shown in FIG. 1, each one of the nodes 120a-120d may utilize one or more coherence links for inter-node access of processor on-die caches and off-die memory of another one of the nodes 120a-120d. In the embodiment shown, the nodes 120a-120d use coherence links 130a-130c, 132a-132b, and 134. As used herein, coherence links may also be referred to as simply links. Although a single link is used between any two nodes in FIG. 1, other embodiments may comprise a different number of links between any two nodes. The dedicated cache coherence links 130a-130c, 132a-132b, and 134 provide communication separate from other communication channels such as a front side bus protocol, a chipset component protocol, and so forth.

The dedicated cache coherence links 130a-130c, 132a-132b, and 134 may provide near-linear scaling of performance with thread count. In various embodiments, the links 130a-130c, 132a-132b, and 134 include packet-based, bidirectional serial/parallel high-bandwidth, low-latency point-to-point communication. In addition, the interconnect technology uses a cache coherency extension. Examples of the technology include HyperTransport and QuickPath. Other proprietary coherence link technologies may also be selected for use on links 130a-130c, 132a-132b, and 134. In other embodiments, the links 130a-130c, 132a-132b, and 134 may be unidirectional, but still support a cache coherency extension. In addition, in other embodiments, the links 130a-130c, 132a-132b, and 134 may not be packet-based, but use other forms of data transport.

As shown, the multi-node computing system 100 is expanded in a “glueless” configuration that does not use an application specific integrated circuit (IC) hub or a full custom IC hub for routing. Alternatively, the multi-node computing system 100 may be expanded with the use of a hub, especially when the number of sockets reaches an appreciable value and development costs account for the extra hardware and logic.

The hardware 110, which includes the nodes 120a-120d, may be connected to software 140. The software 140 may include a hypervisor 142. The hypervisor 142 is used to support a virtualized computing system. Virtualization broadly describes the separation of a service request from the underlying physical delivery of that service. A software layer, or virtualization layer, may be added between the hardware and the operating system (OS). A software layer may run directly on the hardware without the need of a host OS. This type of software layer is referred to as a hypervisor. The hypervisor 142 may allow for time-sharing a single computer between several single-tasking OSes.

The node link status controller 144 may send control signals to the nodes 120a-120d for performing training of the links 130a-130c, 132a-132b, and 134 during system startup and initialization. An electrical section of the physical layer within each of the links 130a-130c, 132a-132b, and 134 manages the transmission of digital data in the one or more lanes within a single link. The electrical section drives the appropriate voltage signal levels with the proper timing relative to a clock signal. Additionally, it recovers the data at the other end of the link and converts it back into digital data. The logical section of the physical layer interfaces with the link layer and manages the flow of information back and forth between them. With the aid of the controller 144, it also handles initialization and training of the link.

Each of the nodes 120a-120d may determine whether respective links are congested. A link may be considered congested in response to a requested bandwidth for the link exceeding the bandwidth capacity of the link. When a given node determines a given link is congested, the given node may become a candidate for data forwarding and use one or more intermediate nodes to route data. In one example, the node 120a may determine link 130a is congested in an outgoing direction toward the node 120b. The node 120a may determine whether one or more of the other nodes 120c and 120d may be used as an intermediate node in a data forwarding path to the destination node 120b. Based on information passed from other nodes to the node 120a, the node 120a may determine the links 130b and 132a are not only non-congested, but these links may additionally be underutilized. Therefore, the node 120a may forward data and possibly requests for data on link 130b to node 120d being used as an intermediate node. Following, the node 120d may forward the data and requests on line 132a to the destination node 120b.

Watermark values for ingress and egress queues, measured incoming request rates, and measured outgoing data transport rates may be used to determine congestion of a given link of the links 130a-130c, 132a-132b, and 134. Time period and threshold values may be stored in a configuration file within the data 146 in the software 140 and later written into corresponding registers of the configuration and status registers in the coherence unit of a node. These time period and threshold values may be programmable.

A unidirectional link includes one or more lanes for data transfer in a particular direction, such as from node 120a to node 120b. A bidirectional link includes two directions, each comprising one or more lanes for data transfer. In some embodiments, each node monitors a same direction for each of its links. For example, a given node may monitor an outgoing direction for each connected bidirectional link and outgoing unidirectional link. Although an outgoing direction for data transport is being monitored, an ingress queue storing incoming data requests to be later sent out on the outgoing direction of the link may also be monitored.

In other embodiments, a given node may monitor both incoming and outgoing directions of connected links. Accordingly, another node connected to the given node may not monitor any directions of the links shared with the given node, since the given node has all information regarding requested bandwidth of each direction of the links between them. If a given link is determined to be congested, then steps may be taken to perform data forwarding, such as identifying one or more intermediate nodes to use to transfer data. Further details are provided below.

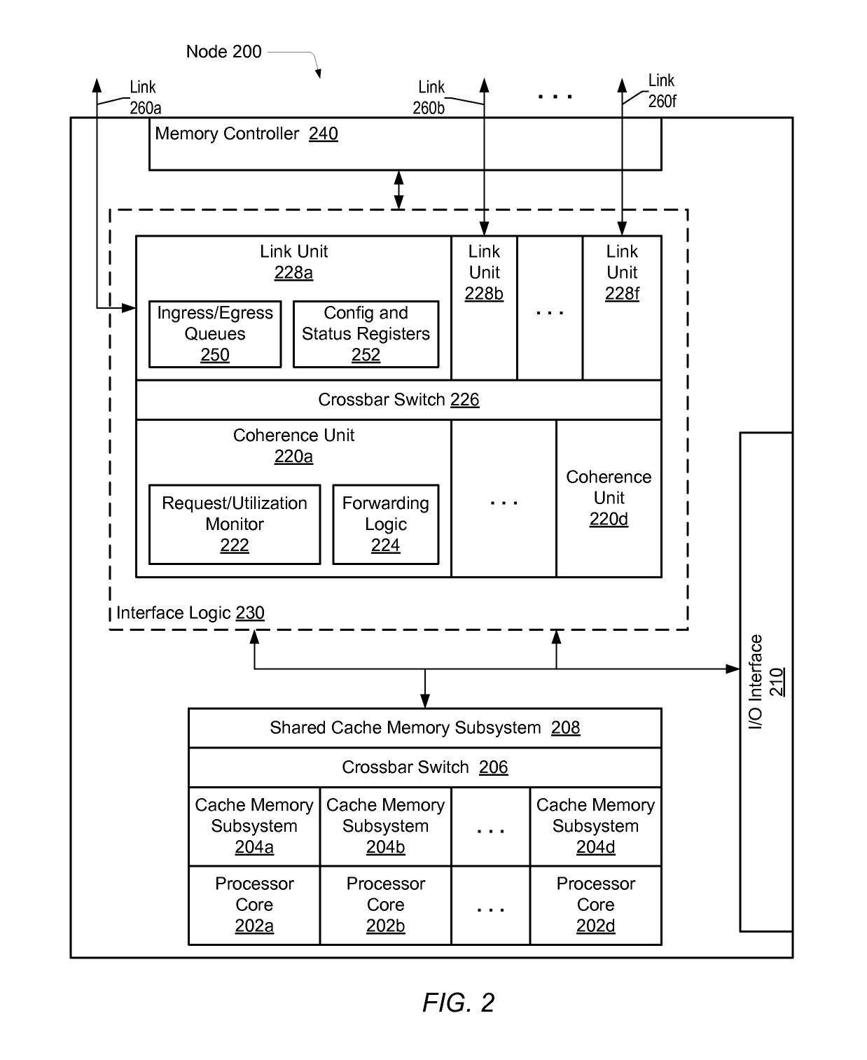

Referring now to FIG. 2, a generalized block diagram of one embodiment of an exemplary node 200 is shown. Node 200 may include memory controller 240, input/output (I/O) interface logic 210, interface logic 230, and one or more processor cores 202a-202d and corresponding cache memory subsystems 204a-204d. In addition, node 200 may include a crossbar switch 206 and a shared cache memory subsystem 208. In one embodiment, the illustrated functionality of processing node 200 is incorporated upon a single integrated circuit.

In one embodiment, each of the processor cores 202a-202d includes circuitry for executing instructions according to a given general-purpose instruction set. For example, the SPARC® instruction set architecture (ISA) may be selected. Alternatively, the x86®, x86-64®, Alpha®, PowerPC®, MIPS®, PA-RISC®, or any other instruction set architecture may be selected. Each of the processor cores 202a-202d may include a superscalar microarchitecture with one or more multi-stage pipelines. Also, each core may be designed to execute multiple threads. A multi-thread software application may have each of its software threads processed on a separate pipeline within a core, or alternatively, a pipeline may process multiple threads via control at certain function units.

Generally, each of the processor cores 202a-202d accesses an on-die level-one (L1) cache within a cache memory subsystem for data and instructions. There may be multiple on-die levels (L2, L3 and so forth) of caches. In some embodiments, the processor cores 202a-202d share a cache memory subsystem 208. If a requested block is not found in the caches, then a read request for the missing block may be generated and transmitted to the memory controller 240. Interfaces between the different levels of caches may comprise any suitable technology.

The interface logic 230 may generate control and response packets in response to transactions sourced from processor cores and cache memory subsystems located both within the processing node 200 and in other nodes. The interface logic 230 may include logic to receive packets and synchronize the packets to an internal clock. The interface logic may include one or more coherence units, such as coherence units 220a-220d. The coherence units 220a-220d may perform cache coherency actions for packets accessing memory according to a given protocol. The coherence units 220a-220d may include a directory for a directory-based coherency protocol. In various embodiments, the interface logic 230 may include link units 228a-228f connected to the coherence links 260a-260f. A crossbar switch 226 may connect one or more of the link units 228a-228f to one or more of the coherence units 220a-220d. In various embodiments, the interface logic 230 is located outside of the memory controller 240 as shown. In other embodiments, the logic and functionality within the interface logic 230 may be incorporated in the memory controller 240.

In various embodiments, the interface logic 230 includes control logic, which may be circuitry, for determining whether a given one of the links 260a-260f is congested. As shown, each one of the link units 228a-228f includes ingress and egress queues 250 for a respective one of the links 260a-260f. Each one of the link units 228a-228f may also include configuration and status registers 252 for storing programmable time period and threshold values. The interface logic 230 may determine whether a forwarding path using one or more intermediate nodes exists. In some embodiments, the control logic, which may be circuitry, in the interface logic 230 is included in each one of the coherence units 220a-220d. For example, the coherence unit 220a may include bandwidth request and utilization measuring logic 222, and forwarding logic 224. The link units 228a-228f may send information corresponding to the queues 250 and the registers 252 to each of the coherence units 220a-220d to allow the logic to determine congestion and possible forwarding paths.

To determine whether link 260a of the links 260a-260f is congested, in some embodiments, direct link data credits may be maintained within the link unit 228a on node 200. Each one of the links 260a-260f may have an initial amount of direct link data credits. One or more credits may be debited from a current amount of direct link data credits when a data request or data is received and placed in a respective ingress queue in queues 250 for the link 260a. Alternatively, one or more credits may be debited from the current amount of direct link data credits when data requested by another node is received from a corresponding cache or off-die memory and placed in an egress queue in queues 250 for link 260a. One or more credits may be added to a current amount of direct link data credits when a data request or data is processed and removed from a respective ingress queue in queues 250 for link 260a. Alternatively, one or more credits may be added to the current amount of direct link data credits when requested data is sent on link 260a and removed from an egress queue in queues 250 for link 260a. Requests, responses, actual data, type of data (e.g. received requested data, received forwarding data, sent requested data, sent forwarding data) and a size of a given transport, such as a packet size, may each have an associated weight that determines the number of credits to debit or add to the current amount of direct link data credits.

Continuing with the above description for direct link data credits, in response to determining the respective direct link data credits are exhausted and new data are available for sending on link 260a that would utilize those credits, the control logic within the interface logic 230 may determine the link 260a is congested. Alternatively, the direct link data credits may not be exhausted, but the number of available direct link data credits may fall below a low threshold. The low threshold may be stored in one of multiple configuration and status registers in the registers 252. The low threshold may be programmable.

Maintaining a number of direct link data credits may inadvertently indicate the link 260a is congested when the congestion lasts for a relatively short time period. It may be advantageous to prevent the link 260a from becoming a candidate for data forwarding when the link 260a is congested for the relatively short time period. To determine longer, persistent patterns of high requested bandwidth for the link 260a, in other embodiments, an interval counter may be used. An interval counter may be used to define a time period or duration. An interval counter may be paired with a data message counter.

The data message counter may count a number of data messages sent on the link 260a. Alternatively, the data message counter may count a number of clock cycles the link 260a sends data. In yet other uses, the data message counter may count a number of received requests to be later sent on the link 260a. Other values may be counted that indicate an amount of requested bandwidth for the link 260a. Similar to the count of direct link data credits, a weight value may associated with the count values based on whether the received and sent messages are requests, responses, requested data, or forwarded data, and based on a size of a given message or data transport. The interval counter may increment each clock cycle until it reaches a given value, and then resets. When the interval counter reaches the given value, the count value within the data message counter may be compared to a threshold value stored in one of multiple configuration and status registers in registers 252. The count value may be saved and then compared to the threshold value. Afterward, the data message counter may also be reset and begin counting again. The time duration and threshold value may be stored in a configuration file within the utilization threshold and timing data 146 in software 140. These values may be later written into corresponding registers of the configuration and status registers 252. These values may be programmable.

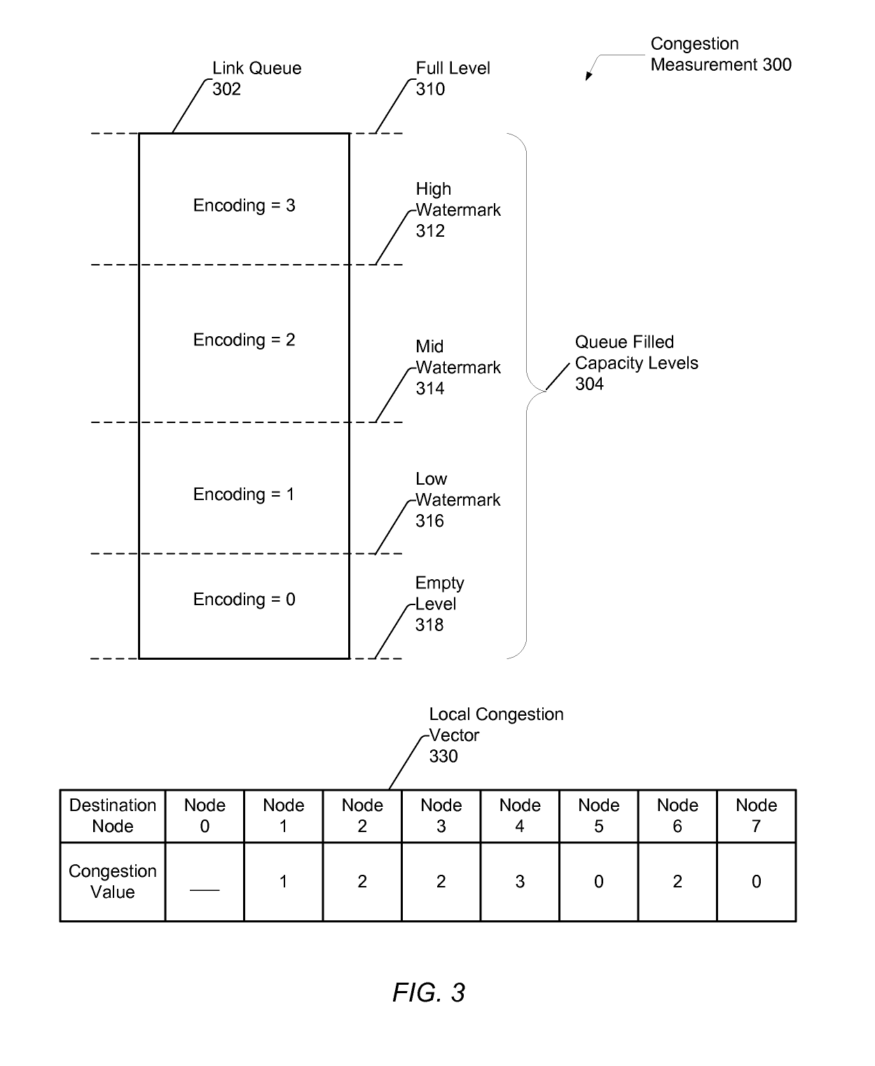

Referring now to FIG. 3, a generalized block diagram of one embodiment of congestion measurement 300 is shown. In some embodiments, each node in a multi-node system has a link egress queue that buffers data before the data are sent out on the link to another node. The data may be arranged in data packets. The link egress queue may be implemented as a first-in-first-out (FIFO) buffer. In the following description, the link queue 302 is described as a link egress queue storing data to be sent on a particular link, but a similar description and use may be implemented for a link ingress queue storing data requests for data to be sent out later on the particular link.

The link queue 302 has varying queue filled capacity levels 304. In some embodiments, the queue filled capacity levels 304 include three watermarks, such as a high watermark 312, a mid watermark 314, and a low watermark 316. In addition, the queue filled capacity levels 304 include a filled capacity level 310 and an empty level 318. Although the following description is using queue filled capacity levels 304, in other embodiments, other criteria may be used, such as a count of direct link data credits, an incoming rate of data requests, an outgoing rate of sending data, an interval counter paired with a capacity measurement or a direct link data credit count or other measurement, etc.

An encoding may be used to describe the manner of measuring request bandwidth of a particular link. For example, when queue filled capacity levels 304 are used, an encoding may be used to represent capacity levels between each of the watermarks 312-316, the full level 310, and the low level 318. An encoding of “0” may be selected to represent a queue capacity between the empty level 318 and the low watermark level 316. An encoding of “1” may be selected to represent a queue capacity between the low watermark level 316 and the mid watermark level 314. The encodings “2” and “3” may be defined in similar manners as shown in FIG. 3.

For a system with N nodes, wherein each node is connected to another node in the system with a single direct link, a given node may include N−1 link egress queues. The encoding information for each of the N−1 link egress queues may be routed to centralized routing control logic within the given node. The centralized routing control logic may be located within the interface logic 230 in node 200. The central routing control logic may collect the encoding status from each of the N−1 link egress queues and form an (N−1)×2-bit vector. The local congestion vector 330 is one example of such a vector for node 0 in an 8-node system using single direct links between any two nodes.

In various embodiments, the local congestion vector 330 may be sent to other nodes in the system at the end of a given interval. In one example, an interval of 100 cycles may be used. The interval time maybe programmable and stored in one of the multiple configuration and status registers. Additionally, if the vector 330 is not updated with different information at the end of the interval, the vector 330 may not be sent to any node.

The vector 330 may be sent to other nodes in the system using a “response” transaction layer packet. The packet may carry ((N−1)×2) bits of congestion information and an identifier (ID) of the source node. Each node may receive N−1 vectors similar to vector 330. The received vectors may be combined to form a global congestion table used for determining the routing of data in the N-node system. Although an N-node system with single direct links between any two nodes is used for the example, in other embodiments, a different number of direct links may be used between any two nodes in the N-node system. The size of the local congestion vector would scale accordingly. Different choices for the placement of the information may be used.

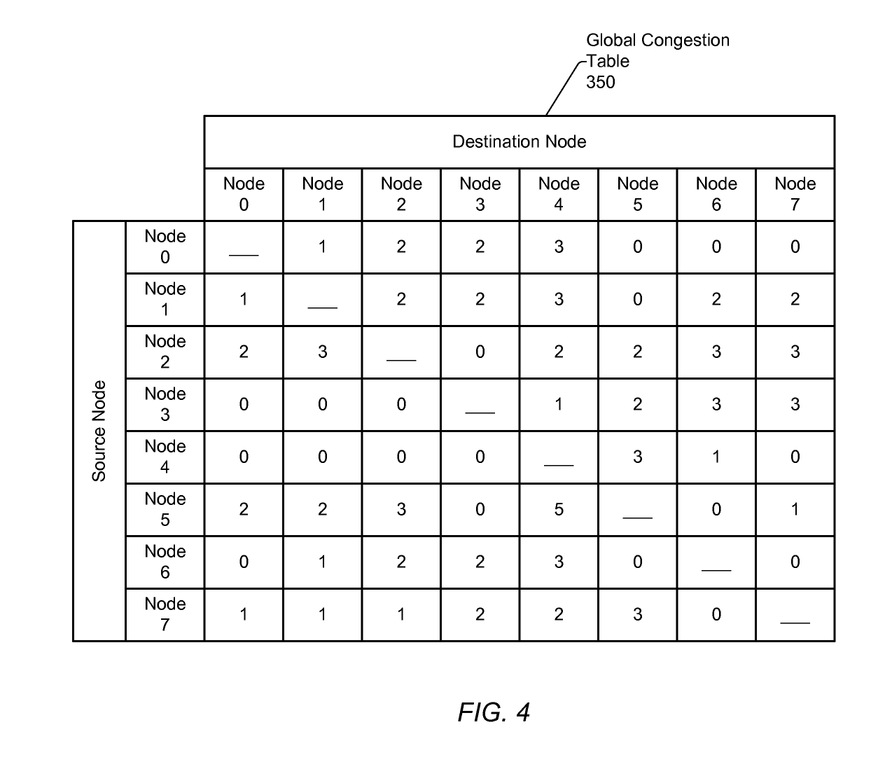

Referring now to FIG. 4, a generalized block diagram illustrating one embodiment of a global congestion table 350 is shown. In various embodiments, each node within a N-node system may receive a local congestion vector from each one of the other nodes in the system. Each node may receive the “response” packets with respective local congestion information and send it to central routing control logic. The vectors may be placed into one row of an N×N matrix or table. The global congestion table 350 is one example of such a table for an 8-node system. Again, although an 8-node system with single direct links between any two nodes is used for the example, in other embodiments, a different number of direct links may be used between any two nodes in an N-node system. The sizes of the local congestion vectors and the size of the global congestion table 350 would scale accordingly. Different choices for the placement of the information may also be used.

One row of the global congestion table 350 may include congestion information received from the local link egress queues. The other N−1 rows of the table 350 may include congestion information from the response packets from other nodes in the system. The global congestion table 350 may be used for routing data in the system. When a given node has data to send to another node, control logic within the given node may lookup the local row in the table 350. If a route from source node to destination node has a congestion value equal to or above a given threshold, then an alternate route may be sought. For example, a given threshold may be “3”, or 2′b11. For node 2, nodes 1, 6, and 7 are considered to be congested according to the table 350.

When a route from source node to destination node is congested, an alternate route may be sought. In one example, the local row may be inspected for links with low or no congestion. For node 2, the node 3 has no congestion. Therefore, node 3 may be a candidate as an intermediate node for an alternate route for an original route of node 2 to node 1. Inspecting the row for node 3 in the global congestion table 350 corresponding to node 3, a congestion value of “0” is found for the route node 3 to node 1. Therefore, the 1^{st} hop of the alternate route, which includes a link between node 2 and node 3, has a congestion value of 0. The 2^{nd} hop of the alternate route, which includes a link between node 3 and node 1, also has a congestion value of 0. For the original route of node 2 to node 1, a data forwarding path using node 3 as an intermediate node may be selected.

A routing algorithm may search for alternate routes, or data forwarding paths, where measured congestion for each hop is below a threshold. When multiple candidates exist for data forwarding paths, a path with a least number of intermediate nodes, thus, a least number of hops, may be selected. If multiple candidate paths have a least number of intermediate nodes, then a round robin, a least-recently-used, or other selection criteria may be used. In addition, a limit of a number of intermediate nodes may be set for candidate paths. If no acceptable alternative route is found, then the data may be sent on the original, direct route.

The routing algorithm may use other criteria in addition to congestion measurements. A given node or one or more links connected to a node may include an initial number of forwarding data credits. Similar to the previously described direct link data credits, the forwarding data credits may be incremented and decremented by a given amount each time data is received for forwarding and each time data is sent to another intermediate node or to a destination node. In addition, an interval counter may be used in combination with a forwarding data message counter. An indication of forwarded data may be sent with the data, such as a single bit or a multi-bit field. Alternatively, the received node may determine the destination node identifier (ID) does not match its own node ID. Using a combination of a count of a number of times a particular node is selected as an intermediate node and a corresponding interval counter may prevent an oscillating “ping pong” of rerouted paths between one another.

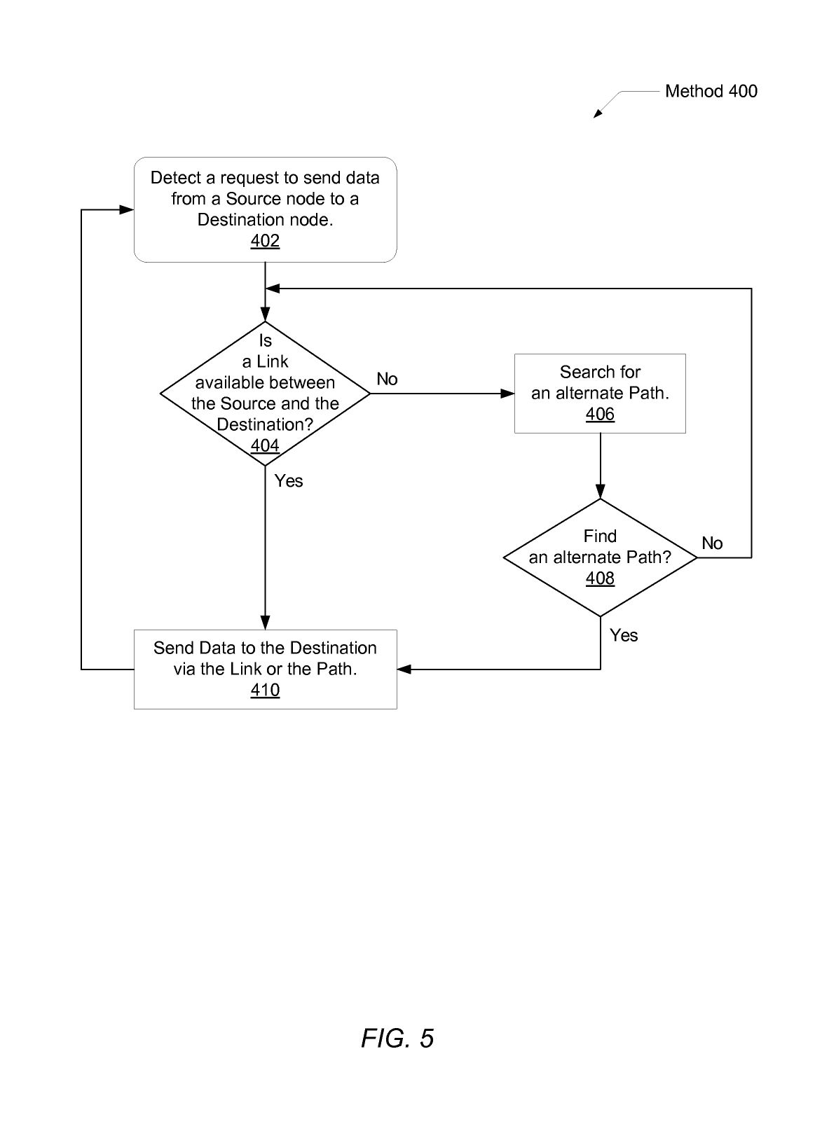

Referring now to FIG. 5, a generalized flow diagram of one embodiment of a method 400 for transporting data in a multi-node system is illustrated. The components embodied in the computing system described above may generally operate in accordance with method 400. For purposes of discussion, the steps in this embodiment are shown in sequential order. However, some steps may occur in a different order than shown, some steps may be performed concurrently, some steps may be combined with other steps, and some steps may be absent in another embodiment.

Program instructions are processed in a multi-node system. A processor and its respective off-die memory may be referred to as a node. A processor within a given node may have access to a most recently updated copy of data in the on-die caches and off-die memory of other nodes through one or more coherence links. Placement of the processors within the nodes may use socket, surface mount, or other technology. The program instructions may correspond to one or more software applications. During processing, each node within the system may access data located in on-die caches and off-die memory of other nodes in the system. Coherence links may be used for the data transfer. In some embodiments, the coherence links are packet-based.

In block 402, a request to send data from a source node to a destination node is detected. The request may correspond to a read or a write memory access request. The request may be detected on an ingress path with an associated queue or an egress path with an associated queue. A link between the source node and the destination node may be unavailable for multiple reasons for transporting corresponding data to the destination node. One reason is the one or more links between the source node and the destination node are congested. These links may have measured congestion levels above a high threshold. A second reason is the one or more links are faulty or are turned off. A third reason is the one or more links capable or configured to transport a particular packet type corresponding to the data are congested, faulty or turned off. Links that are not congested, faulty or turned off may not be configured to transport the particular packet type.

If no link is available between the source node and the destination node (conditional block 404), then in block 406, a search for an alternate path is performed. The search may use measured congestion levels among the nodes in the multi-node system. The alternate path may include one or more intermediate nodes with available links for transport of the corresponding data. If an alternate path is not found (conditional block 408), then control flow of method 400 may return to conditional block 404 where an associated wait may occur. If an alternate path is found (conditional block 408), then in block 410, the data may be transported to the destination node via the alternate path. Similarly, if a link is available between the source node and the destination node (conditional block 404), then in block 410, the data may be transported to the destination node via the available link.

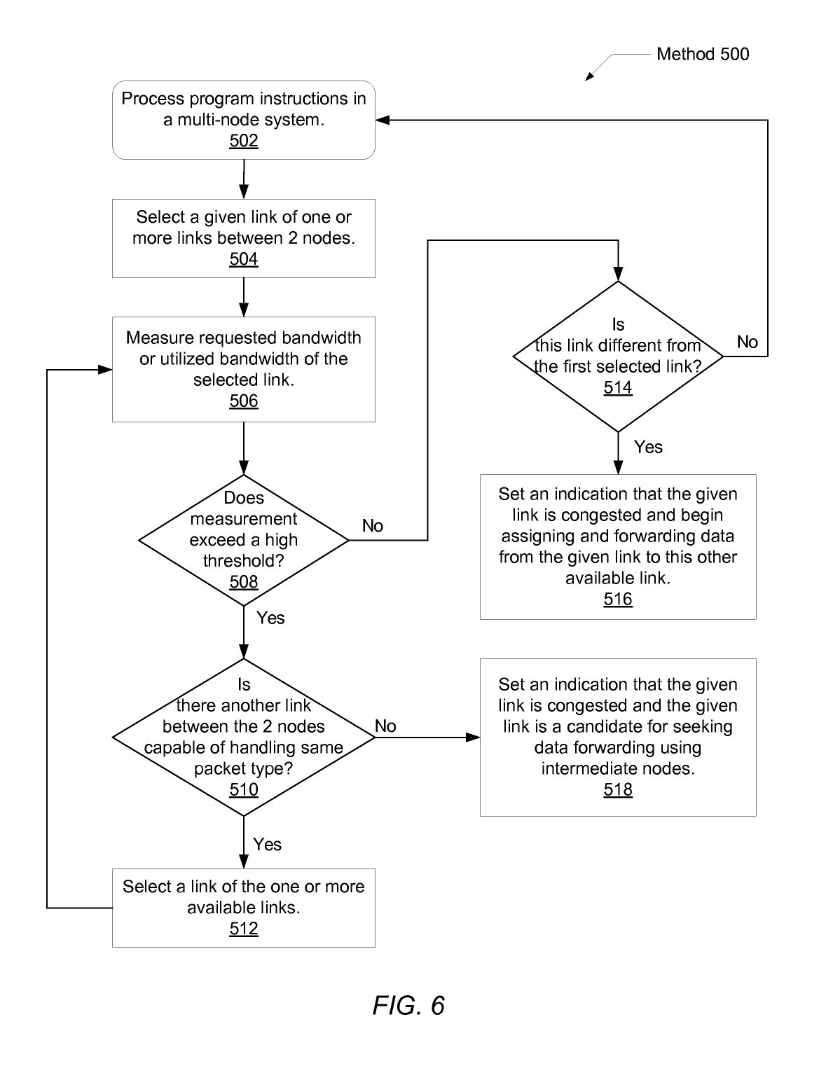

Referring now to FIG. 6, a generalized flow diagram of one embodiment of a method 500 for determining whether a link is a candidate for seeking a data forwarding path is illustrated. The components embodied in the computing system described above may generally operate in accordance with method 500. For purposes of discussion, the steps in this embodiment are shown in sequential order. However, some steps may occur in a different order than shown, some steps may be performed concurrently, some steps may be combined with other steps, and some steps may be absent in another embodiment.

In block 502, program instructions are processed in a multi-node system. In block 504, a given link of one or more links between 2 nodes is selected. In block 506, the requested bandwidth or the utilized bandwidth of the selected link is measured. Measurement may use previously described data message counters and interval counters. The measurement may correspond to a congestion level of the given link.

If the measurement does not exceed a high threshold (conditional block 508), and the link is not different from the first selected link (conditional block 514), then control flow of method 500 returns to block 502. The selected given link may not be considered congested. However, if the link is different from the first selected link (conditional block 514), then in block 516, an indication may be set that indicates the given link is congested and to begin assigning and forwarding data from the given link to this current available link. In this case, another available link between the 2 nodes is non-congested and data may be transported across this available link. Data forwarding may not be used in this case.

If the measurement does exceed a high threshold (conditional block 508) and there is another link between the 2 nodes capable of handling the same packet type (conditional block 510), then in block 512, a link of the one or more available links is selected. Afterward, control flow of method 500 returns to block 506 and a measurement of a congestion level of this selected link is performed. If there is not another link between the 2 nodes capable of handling the same packet type (conditional block 510), then in block 518, an indication is set that the given link is congested and a candidate for seeking data forwarding using intermediate nodes.

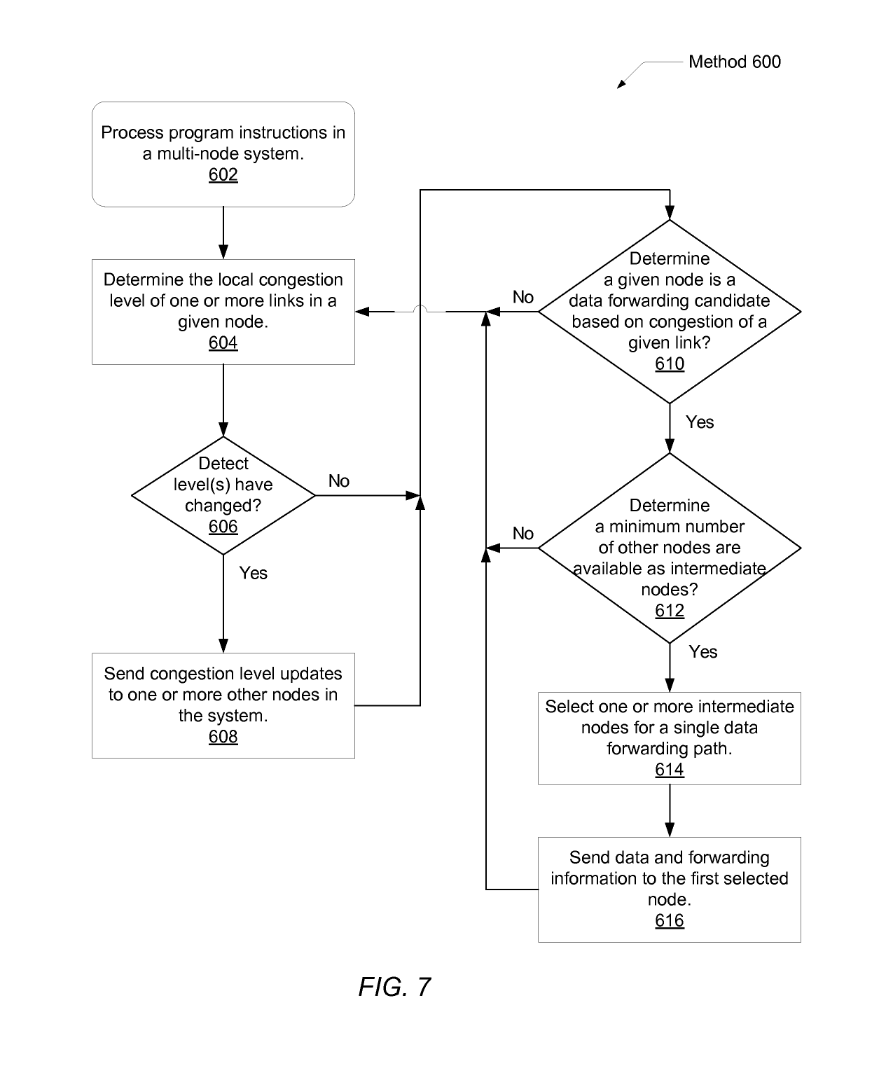

Referring now to FIG. 7, a generalized flow diagram of one embodiment of a method 600 for routing data in a multi-node system with available data forwarding is illustrated. The components embodied in the computing system described above may generally operate in accordance with method 600. For purposes of discussion, the steps in this embodiment are shown in sequential order. However, some steps may occur in a different order than shown, some steps may be performed concurrently, some steps may be combined with other steps, and some steps may be absent in another embodiment.

In block 602, program instructions are processed in a multi-node system. In block 604, the local congestion level of one or more links in a given node is determined. If the congestion level(s) have changed (conditional block 606), then in block 608, the one or more congestion levels are sent to one or more other nodes in the system. In some embodiments, the updated congestion levels are sent at the end of a given time period. An interval counter may be used to determine the time period.

A given node may be a candidate for data forwarding based on congestion of a given link in response to qualifying conditions are satisfied. One condition may be a measured congestion level for the given link exceeds a high threshold. A second condition may be no other links capable of transporting packets of a same particular packet type transported by the given link are available between the given link and a same destination node as used for the given link. Other qualifying conditions are possible and contemplated.

When a given node is determined to be a data forwarding candidate, a search may be performed for one or more intermediate nodes within a data forwarding path. Control logic within the given node may search congestion level information received from other nodes in the system to identify intermediate nodes. In addition, a number of forwarding credits for each of the other nodes may be available and used to identify possible intermediate nodes. If the given node is a candidate for data forwarding based on congestion of a given link (conditional block 610) and a minimum number of other nodes as intermediate nodes are available (conditional block 612), then in block 614, one or more intermediate nodes for a single data forwarding path are selected.

In some embodiments, a least number of intermediate nodes used in the path may have a highest priority for selection logic used to select nodes to be used as intermediate nodes. In other embodiments, a least amount of accumulated measured congestion associated with the links in the path may have a highest priority for selection logic. In block 616, data and forwarding information is sent to the first selected node to be used as an intermediate node in the data forwarding path.

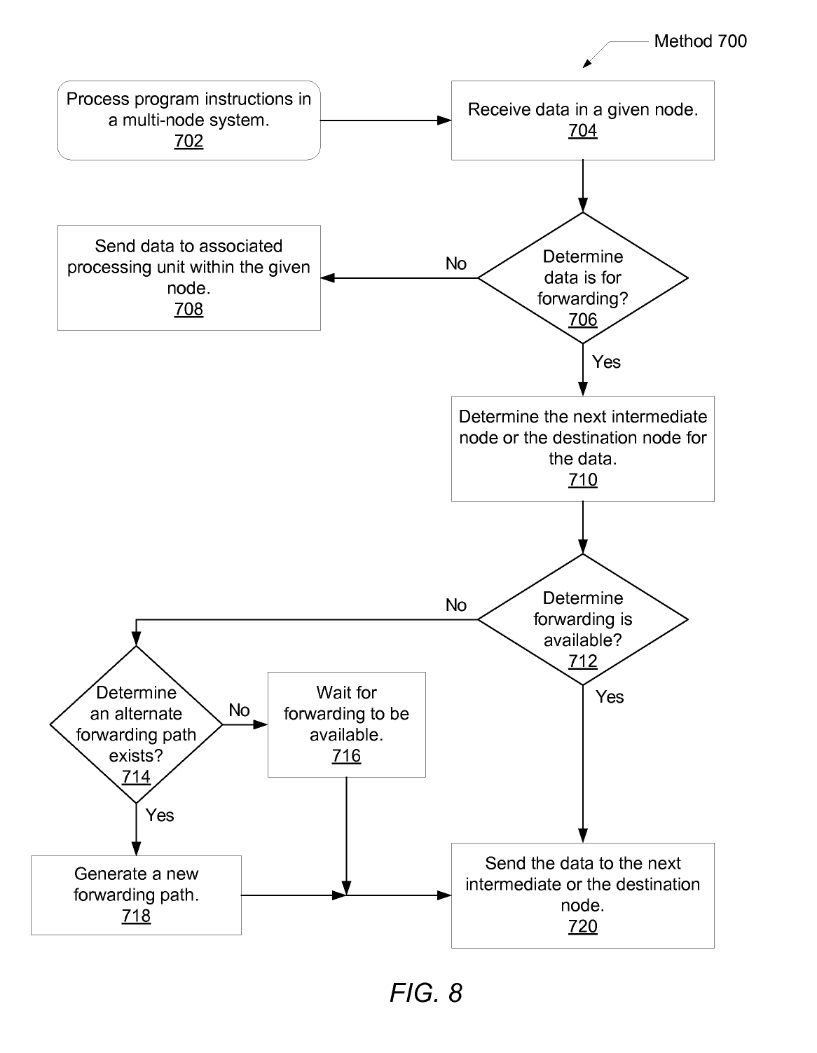

Referring now to FIG. 8, a generalized flow diagram illustrating one embodiment of a method 700 for forwarding data in an intermediate node is shown. The components embodied in the computing system described above may generally operate in accordance with method 700. For purposes of discussion, the steps in this embodiment are shown in sequential order. However, some steps may occur in a different order than shown, some steps may be performed concurrently, some steps may be combined with other steps, and some steps may be absent in another embodiment.

In block 702, program instructions are processed in a multi-node system. In block 704, a given node receives data. In some embodiments, data is transported in packets across the coherence links. A particular bit field within the packet may identify the data as data to be forwarded to another node, rather than serviced within the given node. If it is not determined the data is for forwarding (conditional block 706), then in block 708, the data is sent to an associated processing unit within the given node in order to be serviced. If it is determined the data is for forwarding (conditional block 706), then in block 710, the next intermediate node or the destination node for the data is determined.

In some cases, the intermediate node may not be able to forward the data. Sufficient forwarding credits may not be available. A sufficient number may have been reported earlier, but the credits may have depleted by the time the forwarded data arrived at the intermediate node. If it is determined forwarding is available (conditional block 712), then in block 720, the intermediate node sends the data to the next intermediate node or to the destination node according to the received forwarding information.

If it is determined forwarding is no longer available (conditional block 712), then the intermediate node search for an alternate path using measured congestion levels received from other nodes. If the intermediate node does not search for an alternate path (conditional block 714), then in block 716, the intermediate node may store the data and wait for forwarding to once again be available. If the intermediate node does search for an alternate path (conditional block 714), then in block 718, the intermediate node may generate a new forwarding path. In block 720, the intermediate node sends the data to the next intermediate node or to the destination node according to the received or generated forwarding information.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computing system comprising:
a plurality of nodes connected to one another via one or more links, wherein each of the plurality of nodes is configured to measure a congestion level for each of the one or more links to which it is connected;
wherein in response to a source node determining a link between the source node and a destination node is unavailable, the source node is configured to search for an alternate path between the source node and the destination node.

2. The computing system as recited in claim 1, wherein each of the plurality of nodes is further configured to send measured link congestion levels to each of the other nodes of the plurality of nodes.

3. The computing system as recited in claim 2, wherein congestion levels for the links are measured by determining at least one of the following for a given link: a count or rate of incoming requests for data to be later sent on the given link and a count or rate of outgoing packets sent on the given link.

4. The computing system as recited in claim 2, wherein the source node is further configured to determine a first link between the source node and a first intermediate node has a measured congestion level below a low threshold.

5. The computing system as recited in claim 4, wherein to determine the first link has a measured congestion level below the low threshold, the source node is further configured to search the measured congestion levels performed within the source node for a link between the source node and another node with a congestion level below the low threshold.

6. The computing system as recited in claim 4, wherein in response to determining no link between the first intermediate node and the destination node has a measured congestion level below the low threshold, the source node is further configured to search the measured congestion levels received from each of the other nodes for a second intermediate node with at least one link to the first intermediate node and at least one link to the destination node each with a congestion level below the low threshold.

7. The computing system as recited in claim 5, wherein in response to determining a second link between the first intermediate node and the destination node has a measured congestion level below the low threshold, the source node is further configured to reroute said packet to the destination node through the first link, the first intermediate node, and the second link.

8. The computing system as recited in claim 7, wherein to determine the second link has a measured congestion level below the low threshold, the source node is further configured to search the measured congestion levels received from each of the other nodes for a link between the destination node and another node with a congestion level below the low threshold.

9. The computing system as recited in claim 7, wherein the source node is further configured to select the first intermediate node from multiple nodes with at least one link to the source node and at least one link to the destination node with a measured congestion level below the low threshold using at least one of the algorithms: round robin and least-recently-used.

10. A method for use in a node, the method comprising:
measuring a congestion level for each of one or more links connected to a given node of a plurality of nodes connected to one another via one or more links; and
searching for an alternate path between a source node and a destination node, in response to determining a link between the source node and the destination node is unavailable.

11. The method as recited in claim 10, further comprising sending measured congestion levels from each of the nodes to each other node of the plurality of nodes.

12. The method as recited in claim 11, wherein congestion levels for the links are measured by determining at least one of the following for a given link: a count or rate of incoming requests for data to be later sent on the given link and a count or rate of outgoing packets sent on the given link.

13. The method as recited in claim 11, further comprising determining a first link between the source node and a first intermediate node has a measured congestion level below a low threshold.

14. The method as recited in claim 13, wherein to determine the first link has a measured congestion level below the low threshold, the method further comprises searching the measured congestion levels performed within the source node for a link between the source node and another node with a congestion level below the low threshold.

15. The method as recited in claim 13, wherein in response to determining no link between the first intermediate node and the destination node has a measured congestion level below the low threshold, the method further comprises searching the measured congestion levels performed by each of the other nodes for a second intermediate node with at least one link to the first intermediate node and at least one link to the destination node each with a congestion level below the low threshold.

16. The method as recited in claim 14, wherein in response to determining a second link between the first intermediate node and the destination node has a measured congestion level below the low threshold, the method further comprises rerouting said packet to the destination node through the first link, the first intermediate node, and the second link.

17. A non-transitory computer readable storage medium storing program instructions operable to efficiently transport data across multiple processors when link utilization is congested, wherein the program instructions are executable by a processor to:
measure a congestion level for each of one or more links connected to a given node of a plurality of nodes connected to one another via one or more links; and
search for an alternate path between a source node and a destination node, in response to determining a link between the source node and the destination node is unavailable.

18. The storage medium as recited in claim 17, wherein the program instructions are further executable to send measured congestion levels from each of the nodes to each other node of the plurality of nodes.

19. The storage medium as recited in claim 18, wherein to determine a first link between the source node and a first intermediate node has a measured congestion level below a low threshold, the program instructions are further executable to search the measured congestion levels performed within the source node for a link between the source node and another node with a congestion level below the low threshold.

20. The storage medium as recited in claim 19, wherein in response to determining a second link between the first intermediate node and the destination node has a measured congestion level below the low threshold, the program instructions are further executable to reroute said packet to the destination node through the first link, the first intermediate node, and the second link.
